(19) United States
(12) Patent Application Publication
(10) Pub. No.: US 2014/0286776 A1
(43) Pub. Date: Sep. 25, 2014

(54) Blade Pitch System for a Wind Turbine Generator and Method of Operating the Same

(71) Applicants: Meng Gao, Shanghai (CN); Haiqi Zhao, Shanghai (CN)

(72) Inventors: Meng Gao, Shanghai (CN); Haiqi Zhao, Shanghai (CN)

(73) Assignee: General Electric Company

(21) Appl. No.: 14/353,612

(22) PCT Filed: Oct. 28, 2011
(86) PCT No.: PCT/CN2011/081472

§ 371 Date: Apr. 23, 2014

(51) Int. Cl. F03D 7/02; F03D 7/04

(52) U.S. Cl. CPC F03D 7/0224; F03D 7/042
USPC 416/155

(57) ABSTRACT

A wind turbine blade pitch control system includes a blade pitch drive mechanism coupled to a wind turbine blade and an electric power source coupled to the blade pitch drive mechanism. The system also includes switch devices coupled to portions of the electric power source, and the switch devices are coupled to the blade pitch drive mechanism. The system further includes a controller coupled to the blade pitch drive mechanism and the switch devices. The controller is configured to store a plurality of operational measurements of the blade pitch drive mechanism and the switch devices. The controller is programmed to change an angular rate of change of a pitch angle of the wind turbine blade by opening and closing the switch devices in a predetermined sequence.

### BACKGROUND OF THE INVENTION

The subject matter described herein generally relates to wind turbine generators and, more particularly, to a method and system for adjusting the pitch of blades of a wind turbine generator during a grid contingency event.

Wind turbine generators utilize wind energy to produce electrical power. At least some known wind turbine generators include a rotor having multiple blades that transform wind energy into rotational motion of a drive shaft, which in turn is utilized to drive an electrical generator to produce electrical power. Each of the multiple blades may be pitched to increase or decrease the rotational speed of the rotor. A power output of a wind turbine generator increases with wind speed until the wind speed reaches a rated wind speed for the turbine. At and above the rated wind speed, the wind turbine generator operates at a rated power. The rated power is an output power at which a wind turbine generator can operate with a level of fatigue to turbine components that is predetermined to be acceptable. The frequency of the electric power generated by the variable speed wind turbine is proportional to the speed of rotation of the rotor. However, variable speed operation of the wind turbine produces electric power having varying voltage and/or frequency. A power converter may be coupled between the wind turbine's electric generator and an electric utility grid. The power converter receives the electric power from the wind turbine generator and transmits electricity having a fixed voltage and frequency for further transmission to the utility grid by a transformer. Also, many known wind turbine generators receive electric power from the grid through the power converter to operate auxiliary loads, such as blade pitch drive mechanisms, when the wind turbine generator is not in service.

At least some known wind turbine generators may not be able to operate through certain grid events, since wind turbine control devices require a finite period of time to sense the event, and then make adjustments to wind turbine operation to take effect after detecting such grid event. Such grid events include electrical faults that, under certain circumstances, may induce grid voltage fluctuations that may include low voltage transients with voltage fluctuations that approach zero volts. Also, some grid events may result in a zero voltage condition for an extended period of time, and the wind turbines may be removed from service. Under such conditions, the wind turbine control devices will attempt to reduce loads on the wind turbine by regulating the pitch of the blades to decelerate the rotor, in order to protect wind turbine components against damage.

For many known wind turbine generators, controlled pitching of the blades using an emergency battery backup power supply is the most effective method of decelerating the wind turbine rotor in the event of a simultaneous loss of grid power and wind turbine power electrical generation. Some known blade pitch control circuits include direct current (DC) power from a battery system transmitted to a blade pitch drive motor through a converter that includes a DC intermediate circuit and a DC chopper controller to provide adjustable DC power to change the pitch rate of the blade pitch drive motor. However, such an emergency control configuration requires additional cabling between the battery system and the converter, thereby increasing the costs of installation. Additionally, proper operation of the blade pitch drive motors depends upon reliable operation of the DC chopper controller in the event of a total loss of power.

### BRIEF DESCRIPTION OF THE INVENTION

In one aspect, a wind turbine blade pitch control system is provided. The control system includes at least one blade pitch drive mechanism coupled to a wind turbine blade and at least one electric power source coupled to the blade pitch drive mechanism. The electric power source includes a first portion and a second portion. The system further includes at least two switch devices coupled to at least one of the first portion and the second portion of the electric power source, and the switch devices are coupled to the blade pitch drive mechanism. The system also includes a controller coupled to the blade pitch drive mechanism and the switch devices. The controller is configured to store a plurality of operational measurements of the blade pitch drive mechanism and the switch devices. The controller is programmed to change an angular rate of change of a pitch angle of the wind turbine blade by opening and closing the switch devices in a predetermined sequence.

In another aspect, a method of operating a wind turbine generator is provided. The wind turbine generator includes at least one wind turbine blade and at least one blade pitch drive mechanism coupled to the wind turbine blade. The method includes coupling one of a plurality of portions of an electric power source to the blade pitch drive mechanism by closing one of a plurality of switch devices. The method also includes controlling an angular rate of change of a pitch angle of the wind turbine blade by opening and closing the plurality of switch devices in a predetermined sequence to drive the blade pitch drive mechanism at predetermined angular rates.

In still another aspect, a wind turbine generator is provided. The wind turbine generator includes at least one wind turbine blade and a blade pitch control system. The pitch control system includes at least one blade pitch drive mechanism coupled to the wind turbine blade and at least one electric power source coupled to the blade pitch drive mechanism. The electric power source includes a first portion and a second portion. The system further includes at least two switch devices coupled to at least one of the first portion and the second portion of the electric power source, and the switch devices are coupled to the blade pitch drive mechanism. The system also includes a controller coupled to the blade pitch drive mechanism and the switch devices. The controller is configured to store a plurality of operational measurements of the blade pitch drive mechanism and the switch devices. The controller is programmed to change an angular rate of change of a pitch angle of the wind turbine blade by opening and closing the switch devices in a predetermined sequence.

### BRIEF DESCRIPTION OF THE DRAWINGS

FIG. 1 is a schematic view of an exemplary wind turbine generator.

FIG. 2 is a cross-sectional schematic view of a nacelle that may be used with the wind turbine generator shown in FIG. 1.

FIG. 3 is a schematic view of an exemplary blade pitch control system that may be used with the wind turbine generator shown in FIG. 1.

FIG. 4 is a graphical view of an exemplary blade pitch angle control strategy for a single blade that may be used with the blade pitch control system shown in FIG. 3.

FIG. 5 is a flow chart of an exemplary method of assembling the blade pitch control system shown in FIG. 3.

FIG. 6 is a flow chart of an exemplary method of operating the blade pitch control system shown in FIG. 3.

### DETAILED DESCRIPTION OF THE INVENTION

As used herein, the term “blade” is intended to be representative of any device that provides reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind turbine generator” is intended to be representative of any wind turbine that includes an electric power generation device that generates electrical power from rotational energy generated from wind energy, and more specifically, converts mechanical energy converted from kinetic energy of wind to electrical power.

Technical effects of the methods, apparatus, and systems described herein include at least one of: (a) modulating direct current (DC) power to a plurality of blade pitch drive motors to control the rate of change of blade pitch on each blade to decelerate a wind turbine rotor in a predetermined manner; and (b) modulating the DC power transmitted to the blade pitch drive motors by operating a plurality of switches to place portions of a battery array into service and removing portions of the battery array from service.

The methods, apparatus, and systems described herein facilitate operation of wind turbine generators by actively controlling blade pitch during unplanned shutdowns of the wind turbine generators. Such methods, apparatus, and systems include implementation of a blade pitch control system that modulates the rate of change of the pitch angles of each of a plurality of wind turbine blades as a function of time. Specifically, modulating the rate of change of the pitch angles for each blade facilitates decelerating the wind turbine rotor in a predetermined manner. Further, specifically, decelerating the wind turbine rotor in a predetermined manner facilitates reducing a potential for accelerated component wear.

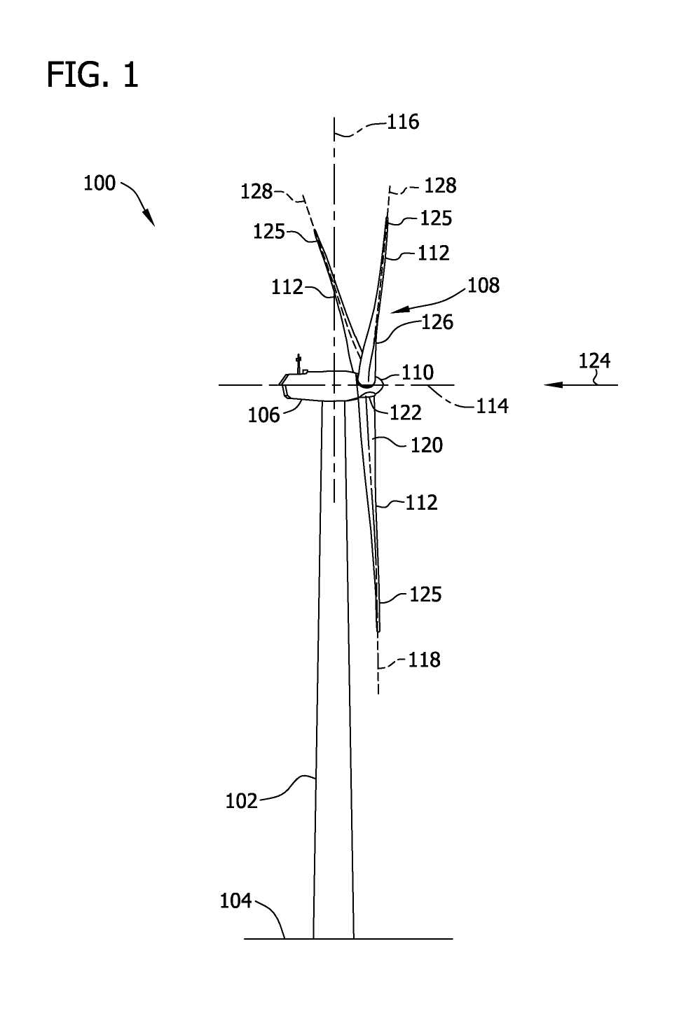

FIG. 1 is a schematic view of an exemplary wind turbine generator 100. In the exemplary embodiment, wind turbine generator 100 is a horizontal axis wind turbine. Alternatively, wind turbine 100 may be a vertical axis wind turbine. Wind turbine 100 has a tower 102 extending from a supporting surface 104, a nacelle 106 coupled to tower 102, and a rotor 108 coupled to nacelle 106. Rotor 108 has a rotatable hub 110 and a plurality of rotor blades 112 coupled to hub 110. In the exemplary embodiment, rotor 108 has three rotor blades 112. Alternatively, rotor 108 has any number of rotor blades 112 that enables wind turbine generator 100 to function as described herein. In the exemplary embodiment, tower 102 is fabricated from tubular steel and has a cavity (not shown in FIG. 1) extending between supporting surface 104 and nacelle 106. Alternatively, tower 102 is any tower that enables wind turbine generator 100 to function as described herein including, but not limited to, a lattice tower. The height of tower 102 is any value that enables wind turbine generator 100 to function as described herein.

Blades 112 are positioned about rotor hub 110 to facilitate rotating rotor 108, thereby transferring kinetic energy from wind 124 into usable mechanical energy, and subsequently, electrical energy. Rotor 108 and nacelle 106 are rotated about tower 102 on a yaw axis 116 to control the perspective of blades 112 with respect to the direction of wind 124. Blades 112 are mated to hub 110 by coupling a blade root portion 120 to hub 110 at a plurality of load transfer regions 122. Load transfer regions 122 have a hub load transfer region and a blade load transfer region (both not shown in FIG. 1). Loads induced in blades 112 are transferred to hub 110 by load transfer regions 122. Each of blades 112 also includes a blade tip portion 125.

In the exemplary embodiment, blades 112 have a length between 50 meters (m) (164 feet (ft)) and 100 m (328 ft), however these parameters form no limitations to the instant disclosure. Alternatively, blades 112 may have any length that enables wind turbine generator to function as described herein. As wind 124 strikes each of blades 112, blade lift forces (not shown) are induced on each of blades 112 and rotation of rotor 108 about rotation axis 114 is induced as blade tip portions 125 are accelerated. A pitch angle (not shown) of blades 112, i.e., an angle that determines each of blades' 112 perspective with respect to the direction of wind 124, may be changed by a pitch adjustment mechanism (not shown in FIG. 1). Specifically, increasing a pitch angle of blade 112 decreases a percentage of area 126 exposed to wind 124 and, conversely, decreasing a pitch angle of blade 112 increases a percentage of area 126 exposed to wind 124.

For example, a blade pitch angle of approximately 0 degrees (sometimes referred to as a “power position”) exposes a significant percentage of a blade surface area 126 to wind 124, thereby resulting in inducement of a first value of lift forces on blade 112. Similarly, a blade pitch angle of approximately 90 degrees (sometimes referred to as a “feathered position”) exposes a significantly lower percentage of blade surface area 126 to wind 124, thereby resulting in inducement of a second value of lift forces on blade 112. The first value of lift forces induced on blades 112 is greater than the second value of lift forces induced on blades 112 such that values of lift forces are directly proportional to blade surface area 126 exposed to wind 124. Therefore, values of lift forces induced on blades 112 are indirectly proportional to values of blade pitch angle.

Also, for example, as blade lift forces increase, a linear speed of blade tip portion 125 increases. Conversely, as blade lift forces decrease, linear speed of blade tip portion 125 decreases. Therefore, values of linear speed of blade tip portion 125 are directly proportional to values of lift forces induced on blades 112 and it follows that linear speed of blade tip portion 125 is indirectly proportional to blade pitch angle.

Moreover, as speed of blade tip portion 125 increases, an amplitude (not shown) of acoustic emissions (not shown in FIG. 1) from blade 112 increases. Conversely, as speed of blade tip portion 125 decreases, an amplitude of acoustic emissions from blades 112 decreases. Therefore, the amplitude of acoustic emissions from blades 112 is directly proportional to a linear speed of blade tip portions 125 and, it follows that the amplitude of acoustic emissions from blades 112 is indirectly proportional to the blade pitch angle.

The pitch angles of blades 112 are adjusted about a pitch axis 118 for each of blades 112. In the exemplary embodiment, the pitch angles of blades 112 are controlled individually. Alternatively, the pitch of blades 112 may be controlled as a group. In the exemplary embodiment, the pitch of blades 112 is modulated in order to induce a braking action to expediently reduce the speed of blades 112, and thereby reduce the rotational velocity of rotor 108. Preferably, wind turbine 100 may be controlled to reduce the rotational velocity of rotor 108 by a local controller (not shown), or remotely by a remote controller (not shown).

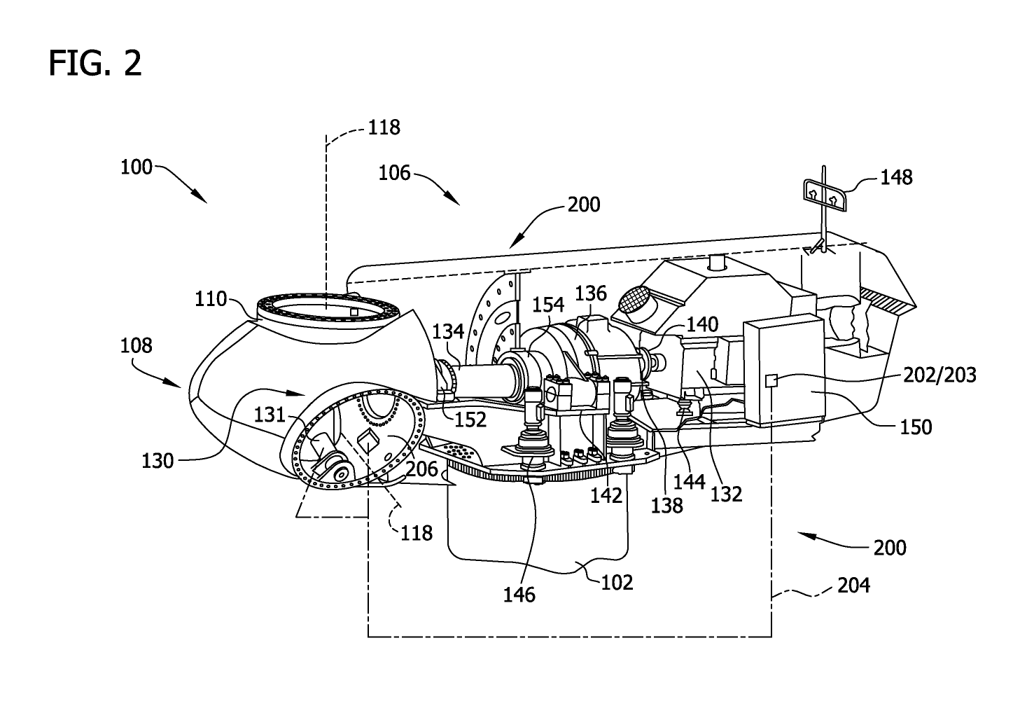

FIG. 2 is a cross-sectional schematic view of nacelle 106 of exemplary wind turbine 100. Various components of wind turbine 100 are housed in nacelle 106 atop tower 102 of wind turbine 100. Nacelle 106 includes one pitch drive mechanism 130 that is coupled to one blade 112 (shown in FIG. 1), wherein mechanism 130 modulates the pitch of associated blade 112 along pitch axis 118. Only one of three pitch drive mechanisms 130 is shown in FIG. 2. In the exemplary embodiment, each pitch drive mechanism 130 includes at least one pitch drive motor 131, wherein pitch drive motor 131 is any electric motor driven by electrical power that enables mechanism 130 to function as described herein. Alternatively, pitch drive mechanisms 130 include any suitable structure, configuration, arrangement, and/or components such as, but not limited to, hydraulic cylinders, springs, and servomechanisms. Moreover, pitch drive mechanisms 130 may be driven by any suitable means such as, but not limited to, hydraulic fluid, and/or mechanical power, such as, but not limited to, induced spring forces and/or electromagnetic forces.

Nacelle 106 also includes a rotor 108 that is rotatably coupled to an electric generator 132 positioned within nacelle 106 by rotor shaft 134 (sometimes referred to as low speed shaft 134), a gearbox 136, a high speed shaft 138, and a coupling 140. Rotation of shaft 134 rotatably drives gearbox 136 that subsequently rotatably drives shaft 138. Shaft 138 rotatably drives generator 132 by coupling 140, wherein shaft 138 rotation facilitates production of electrical power by generator 132. Gearbox 136 and generator 132 are supported by supports 142 and 144, respectively. In the exemplary embodiment, gearbox 136 utilizes a dual path geometry to drive high speed shaft 138. Alternatively, main rotor shaft 134 is coupled directly to generator 132 by coupling 140.

Nacelle 106 further includes a yaw adjustment mechanism 146 that may be used to rotate nacelle 106 and rotor 108 on axis 116 (shown in FIG. 1) to control the perspective of blades 112 with respect to the direction of the wind. Nacelle 106 also includes at least one meteorological mast 148, wherein mast 148 includes a wind vane and anemometer (neither shown in FIG. 2). Mast 148 provides information to a turbine control system (not shown) that may include wind direction and/or wind speed. A portion of the turbine control system resides within a control panel 150. Nacelle 106 further includes forward and aft support bearings 152 and 154, respectively, wherein bearings 152 and 154 facilitate radial support and alignment of shaft 134.

Wind turbine generator 100 includes a pitch control system 200, wherein at least a portion of pitch control system 200 is positioned in nacelle 106, or less preferably, outside nacelle 106. Specifically, at least a portion of pitch control system 200 described herein includes at least one processor 202 and a memory device 203 coupled to processor 202, and at least one input/output (I/O) conduit 204, wherein conduit 204 includes at least one I/O channel (not shown). More specifically, processor 202 is positioned within control panel 150. Pitch control system 200 substantially provides a technical effect of wind turbine noise reduction as described herein.

As used herein, the term processor is not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc—read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Processor 202 and other processors (not shown) as described herein process information transmitted from a plurality of electrical and electronic devices that may include, but are not limited to, blade pitch position feedback devices 206 (described further below) and electric power generation feedback devices (not shown). Memory devices 203 and storage devices (not shown) store and transfer information and instructions to be executed by processor 202. Memory devices 203 and the storage devices can also be used to store and provide temporary variables, static (i.e., non-changing) information and instructions, or other intermediate information to processor 202 during execution of instructions by processor 202. Instructions that are executed include, but are not limited to, resident blade pitch system 200 control commands. The execution of sequences of instructions is not limited to any specific combination of hardware circuitry and software instructions.

In the exemplary embodiment, at least a portion of pitch control system 200 including, but not limited to, processor 202 and memory device 203 are positioned within control panel 150. Moreover, processor 202 and memory device 203 are coupled to blade pitch drive motors 131 by at least one I/O conduit 204. I/O conduit 204 includes any number of channels having any architecture including, but not limited to, Cat 5/6 cable, twisted pair wiring, and wireless communication features. Pitch control system 200 may include distributed and/or centralized control architectures, or any combination thereof.

Pitch control system 200 also includes a plurality of independent blade pitch position devices 206 coupled with processor 202 and memory device 203 by at least one I/O conduit 204. In the exemplary embodiment, each pitch drive mechanism 130 is associated with a single blade pitch position feedback device 206. Alternatively, any number of position feedback devices 206 are associated with each mechanism 130. Therefore, in the exemplary embodiment, mechanism 130 and associated drive motor 131, as well as device 206, are included in system 200 as described herein. Each position feedback device 206 measures a pitch position of each blade 112, or more specifically an angle of each blade 112 with respect to wind 124 (shown in FIG. 1) and/or with respect to rotor hub 110. Position feedback device 206 is any suitable sensor having any suitable location within or remote to wind turbine 100, such as, but not limited to, optical angle encoders, magnetic rotary encoders, and incremental encoders, or some combination thereof. Moreover, position feedback device 206 transmits pitch measurement signals (not shown) that are substantially representative of associated blade 112 pitch position to memory device 203 and then processor 202 for processing thereof.

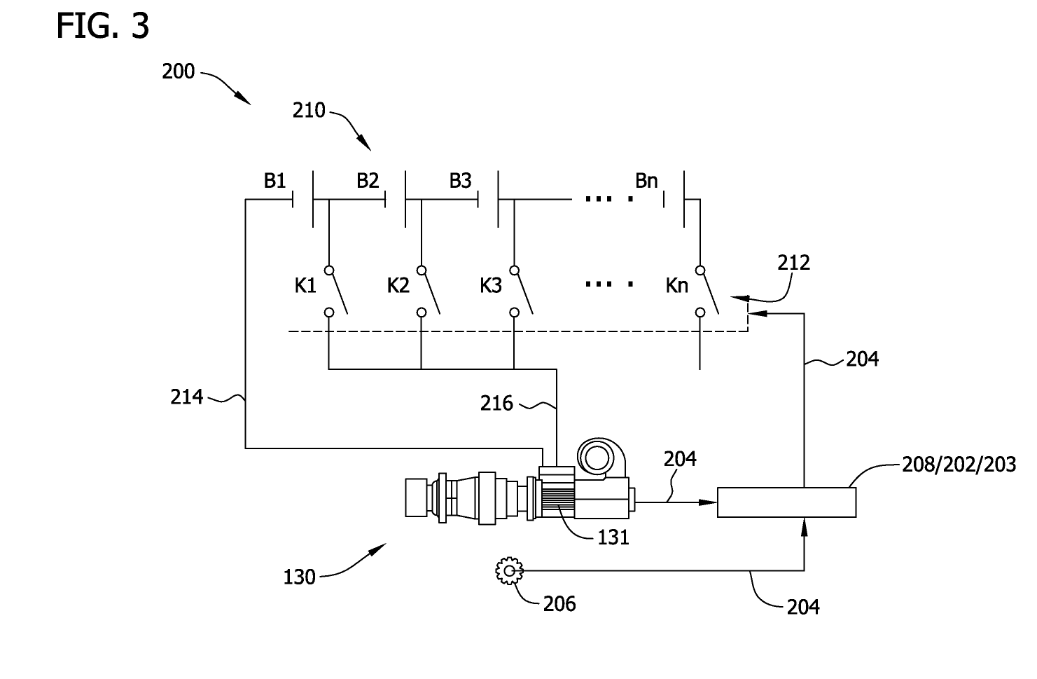

FIG. 3 is a schematic view of blade pitch control system 200 that may be used with wind turbine generator 100 (shown in FIG. 1). In the exemplary embodiment, blade pitch control system 200 includes a controller 208 that includes processor 202 and memory 203 coupled together. Controller 208 is coupled to blade pitch position device 206 and blade pitch drive motor 131 by at least one I/O conduit 204.

Also, in the exemplary embodiment, blade pitch control system 200 includes an electric power source, i.e., a battery array 210. Blade pitch control system 200 also includes a switch array 212 coupled to battery array 210 by a plurality of switch devices including first switch device K1, second switch device K2, third switch device K3, and n^{th} switch device Kn, wherein “n” is any numeral that enables operation of blade pitch control system 200 as described herein. Switch devices K1 through Kn define a plurality of battery portions, or units, including first battery unit B1, second battery unit B2, third battery unit B3, and n^{th} battery unit Bn, wherein “n” is described above. Battery array 210 is coupled to blade pitch drive motor 131 by a first direct current (DC) power conduit 214 and switch array 212 is coupled to blade pitch drive motor 131 by a second DC power conduit 216. Controller 208 is coupled to an actuating mechanism (not shown) and a position feedback mechanism (not shown) in each switch device K1 through Kn within switch array 212 by at least one I/O conduit 204.

In the exemplary embodiment, switch devices K1 through Kn are contactors. Alternatively, any type of switch device may be used that enables operation of blade pitch control system 200 as described herein, including, without limitation, insulated gate bipolar transistors (IGBT) and gate turn-off thyristors (GTOs). Some considerations for selecting the switch devices include, without limitation, cost and operational speed of each switch type. For example, without limitation, switching times for the switch devices may vary from less than one microsecond to multiple milliseconds. In addition, depending on the type of switch device selected, speed control algorithms should be programmed in processor 202 accordingly.

Also, in the exemplary embodiment, a closed-loop proportional-integral-derivative (PID) control scheme is used. Alternatively, rather than typical PID control schemes, a simplified closed-loop control scheme with preset operational contact closing and opening periods and without a rate of pitch feedback feature may be used for contact control. Also, alternatively, open loop control schemes without rate of pitch feedback may also be used, wherein battery units may be coupled to drive motors for various durations that may be fixed or adjustable by control system parameter settings. Although open loop control schemes generally have lower precision than closed loop control schemes, such open loop control schemes typically have a better performance than non-controlled battery pitching.

I/O conduits 204 transmit operational measurements of each switch device K1 through Kn to memory device 203 within controller 208. In the exemplary embodiment, switch devices K1 through Kn are discrete, binary switches with a “closed” state and an “open” state. Blade pitch position device 206 transmits operational measurements of blade 112 (shown in FIG. 1) that extend between the power position and the feathered position defined by blade pitch angles of approximately 0 degrees and 90 degrees, respectively, to memory device 203 within controller 208 by I/O conduits 204. Processor 202 is programmed with at least one differentiating algorithm to determine a rate of pitch. Moreover, blade pitch drive motor 131 transmits operational measurements that include, without limitation, motor current (not shown) as drawn through DC power conduits 214 and 216, to memory device 203.

In operation, processor 202 of controller 208 is programmed with sufficient algorithms and instructions to change a pitch angle of wind turbine blade 112 during grid voltage fluctuations that may include low voltage transients with voltage fluctuations that approach zero volts. Processor 202 commands each switch device K1 through Kn to open and close through a predetermined sequence to facilitate attaining predetermined pitch angle change rates as a function of time. Only one of switch devices K1 through Kn is closed at any one time, thereby coupling a predetermined number of battery units B1 through Bn to blade pitch drive motor 131. Motor 131 is a DC motor that drives the associated blade 112 at a rate that is at least partially determined by the voltage applied to motor 131. Therefore, opening and closing switch devices K1 through Kn changes the voltage induced on motor 131 from battery array 210 to predetermined discrete voltage values, thereby changing the predetermined discrete angular rate of change of the pitch of blade 112. In general, as the value of n increases from 1, the number of battery units Bn increases, the voltage applied to motor 131 increases, and the angular rate of pitch change increases.

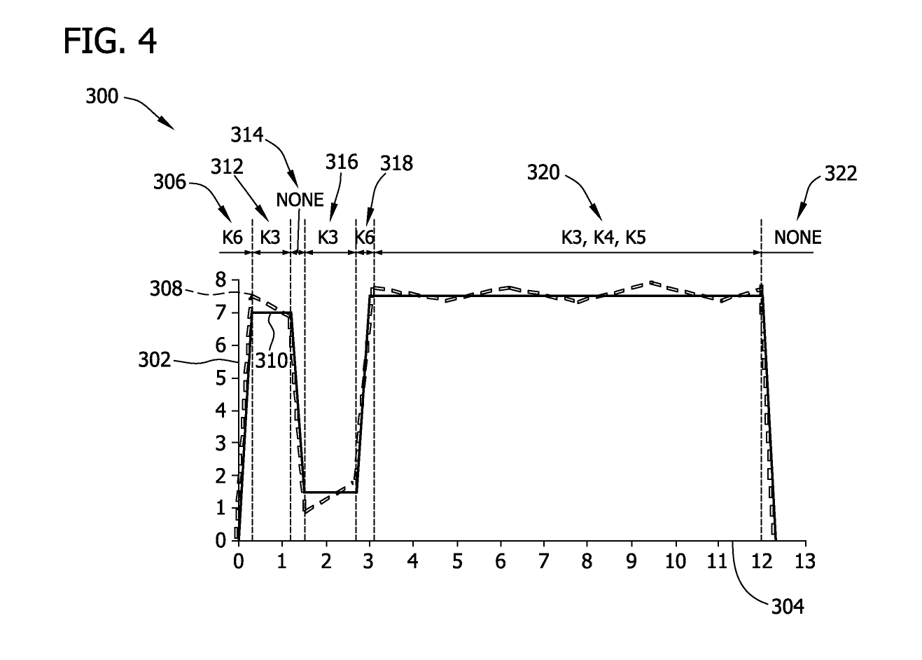

FIG. 4 is a graphical view, i.e., graph 300 of an exemplary blade pitch angle control strategy for a single blade 112 (shown in FIG. 1) that may be used with blade pitch control system (200) shown in FIG. 3. Graph 300 includes an ordinate (y-axis) 302 that represents pitch rate in degrees per second (°/sec) in increments of 1°/sec ranging from 0°/sec to 8°/sec. Graph 300 also includes an abscissa (x-axis) 304 that represents time in seconds (sec) in increments of 1 sec from 0 secs to 13 secs. Graph 300 further includes a first section 306 extending from approximately 0 secs to approximately 0.33 secs along x-axis 304. In the exemplary embodiment, n=6. Referring to FIG. 3 with FIG. 4, switch device K6 closes and switch devices K1 through K5 are open, thereby applying the full voltage of battery array 210 of battery units 1 through 6 in series to blade pitch drive motor 131. Blade 112 (shown in FIG. 1) is rotated about pitch axis 118 (shown in FIG. 1) at a rate of approximately 7.5°/sec, wherein 7.5°/sec is the predetermined high end parameter. Such rate is shown as a portion of an actual rate curve 308 and is compared to a desired rate curve 310.

Graph 300 also includes a second section 312 extending from approximately 0.33 secs along x-axis 304 to approximately 1.1 sec. Switch device K6 opens and switch device K3 closes at approximately 0.33 secs to apply approximately half of the rated voltage of battery array 210, including battery units 1 through 3 in series, to blade pitch drive motor 131. Blade 112 is rotated about pitch axis 118 at a rate that decreases from approximately 7.5°/sec to approximately 7.0°/sec.

Graph 300 further includes a third section 314 extending from approximately 1.1 secs along x-axis 304 to approximately 1.4 sec. Switch device K3 opens and no switch device closes at approximately 1.1 secs to apply approximately zero volts to blade pitch drive motor 131. Blade 112 is rotated about pitch axis 118 at a rate that decreases from approximately 7.0°/sec to approximately 1.0°/sec.

Graph 300 also includes a fourth section 316 extending from approximately 1.4 secs along x-axis 304 to approximately 2.7 sec. Switch device K3 closes at approximately 1.4 secs to apply half of the rated voltage of battery array 210, including battery units 1 through 3 in series, to blade pitch drive motor 131. Blade 112 is rotated about pitch axis 118 at a rate that increases from approximately 1.0°/sec to approximately 2.0°/sec.

Graph 300 also includes a fifth section 318 extending from approximately 2.7 secs along x-axis 304 to approximately 3.1 sec. Switch device K3 opens and switch device K6 closes at approximately 3.1 secs to apply the full voltage of battery array 210 of battery units 1 through 6 in series to blade pitch drive motor 131. Blade 112 is rotated about pitch axis 118 at a rate that increases from approximately 2.0°/sec to approximately 7.8°/sec.

Graph 300 also includes a sixth section 320 extending from approximately 3.1 secs along x-axis 304 to approximately 12.0 sec. Switch devices K3, K4, and K5 open and close successively through the time period such that curve 308 modulates between approximately 7.8°/sec and approximately 7.3°/sec to simulate a steady rate of approximately 7.5°/sec as shown in desired rate curve 310. The applied voltage from battery array 210 to blade pitch drive motor 131 varies accordingly.

Graph 300 further includes a seventh section 322 extending from approximately 12.0 secs along x-axis 304 to approximately 12.3 sec. All switch devices are open and no switch device closes to apply approximately zero volts to blade pitch drive motor 131. Blade 112 is rotated about pitch axis 118 at a rate that decreases from approximately 7.8°/sec to approximately 0.0°/sec. In the exemplary embodiment, processor 202 of controller 208 is programmed to change an angular rate pitch angle of wind turbine blade 112 by opening and closing switch devices K1 through Kn in a predetermined sequence. It is estimated that by this point, i.e., after 12.0 secs, rotor 108 is decelerated sufficiently due to the braking action of blades 118 induced by blade pitch control system 200 to significantly reduce a probability of accelerated wear of components of wind turbine generator 100 due to unplanned grid voltage fluctuations that may include low voltage transients with voltage fluctuations that approach zero volts.

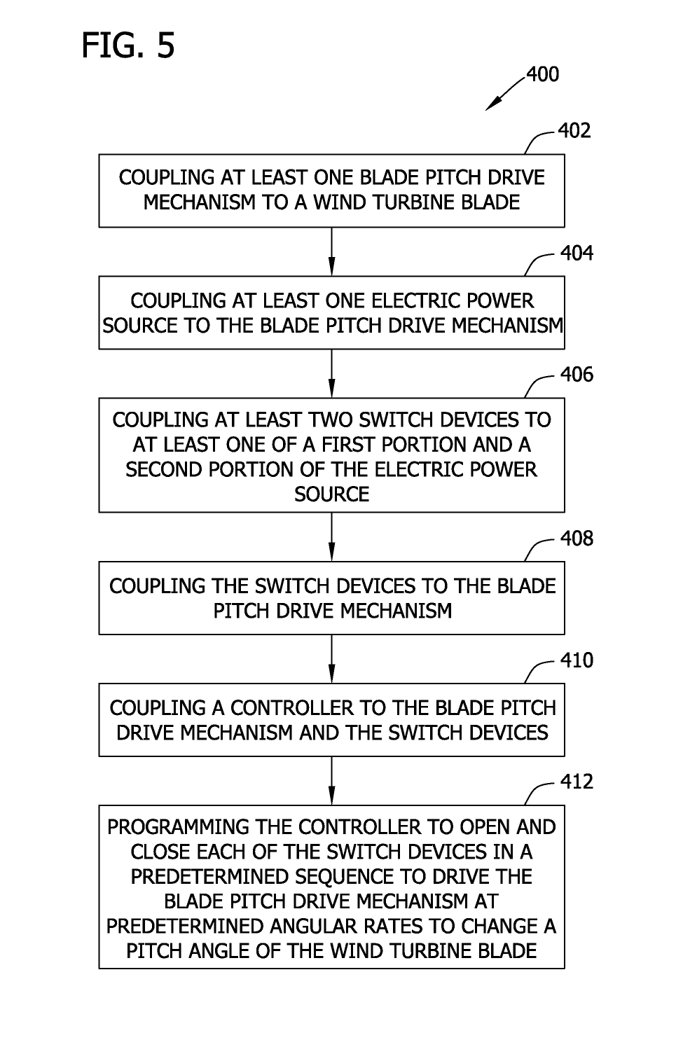

FIG. 5 is a flow chart of an exemplary method 400 of assembling blade pitch control system 200 (shown in FIG. 3). In the exemplary embodiment, at least one blade pitch drive mechanism 130 (shown in FIG. 3) is coupled 402 to wind turbine blade 112 (shown in FIG. 1). At least one electric power source, i.e., battery array 210 (shown in FIG. 3) is coupled 404 to blade pitch drive mechanism 130. At least two switch devices K1 through Kn (shown in FIG. 3) are coupled 406 to at least one of a first portion B1 and a second portion Bn (both shown in FIG. 3) of battery array 210. Switch devices K1 through Kn are coupled 408 to blade pitch drive mechanism 130. Controller 208 (shown in FIG. 3) is coupled 410 to blade pitch drive mechanism 130 and switch devices K1 through Kn. Controller 208 is programmed 412 to open and close each of switch devices K1 through Kn in a predetermined sequence to drive each blade pitch drive mechanism 130 at predetermined angular rates to change a pitch angle of wind turbine blade 112.

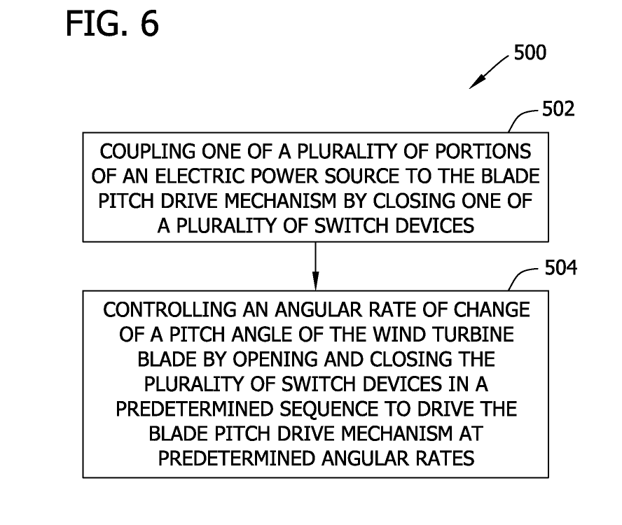

FIG. 6 is a flow chart of an exemplary method 500 of operating blade pitch control system 200 (shown in FIG. 3). In the exemplary embodiment, one of a plurality of portions, i.e., portions B1 through Bn of battery array 210 (all shown in FIG. 3) is coupled 502 to blade pitch drive mechanism 130 (shown in FIG. 3) by closing one of switch devices K1 through Kn (shown in FIG. 3). Also, an angular rate of change of a pitch angle of wind turbine blade 112 (shown in FIG. 1) is controlled 504 by opening and closing switch devices B1 through Bn in a predetermined sequence to drive blade pitch drive mechanism 130 at predetermined angular rates.

The above-described methods, apparatus, and systems facilitate operation of wind turbine generators by actively controlling blade pitch during unplanned shutdowns of the wind turbine generators. Such methods, apparatus, and systems include implementation of a blade pitch control system that modulates the rate of change of the pitch angles of each of a plurality of wind turbine blades as a function of time. Specifically, modulating the rate of change of the pitch angles for each blade facilitates decelerating the wind turbine rotor in a predetermined manner. Further, specifically, decelerating the wind turbine rotor in a predetermined manner facilitates reducing a potential for accelerated component wear.

Exemplary embodiments of methods, apparatus, and systems for operating wind turbine generators are described above in detail. The methods, apparatus, and systems are not limited to the specific embodiments described herein, but rather, components of systems and/or steps of the methods may be utilized independently and separately from other components and/or steps described herein. For example, the methods may also be used in combination with other wind turbine generators, and are not limited to practice with only the wind turbine generator as described herein. Rather, the exemplary embodiment can be implemented and utilized in connection with many other wind turbine generator applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

BLADE PITCH SYSTEM FOR A WIND TURBINE
GENERATOR AND METHOD OF OPERATING THE
SAME
PARTS LIST

| | |
|---|---|
| 100 | Wind Turbine Generator |
| 102 | Tower |
| 104 | Tower Supporting Surface |
| 106 | Nacelle |
| 108 | Rotor |
| 110 | Hub |
| 112 | Blades |
| 114 | Rotation Axis |
| 116 | Yaw Axis |
| 118 | Pitch Axis |
| 120 | Blade Root Portion |
| 122 | Load Transfer Regions |
| 124 | Wind |
| 125 | Blade Tip Portion |
| 126 | Blade Surface Area |
| 130 | Pitch Drive Mechanism |
| 131 | Pitch Drive Motor |
| 132 | Generator |
| 134 | Low Speed Shaft |
| 136 | Gearbox |
| 138 | High Speed Shaft |
| 140 | Coupling |
| 142 | Gearbox Supports |
| 144 | Generator Supports |
| 146 | Yaw Drive Mechanism |
| 148 | Meteorological Mast |
| 150 | Control Panel |
| 152 | Forward Support Bearing |
| 154 | Aft Support Bearing |
| 200 | Blade Pitch Control System |
| 202 | Processor |
| 203 | Memory |
| 204 | Input/Output (I/O) Conduit |
| 206 | Blade Pitch Position Feedback Devices |
| 208 | Controller |
| 210 | Battery Array |
| 212 | Switch Array |
| K1 | First Switch Device |
| K2 | Second Switch Device |
| K3 | Third Switch Device |
| Kn | n^{th} Switch Device |
| B1 | First Battery Unit |
| B2 | Second Battery Unit |
| B3 | Third Battery Unit |
| Bn | n^{th} Battery Unit |
| 214 | First Direct Current (DC) Power Conduit |
| 216 | Second Direct Current (DC) Power Conduit |
| 300 | Graph |
| 302 | Y-axis |
| 304 | X-axis |
| 306 | First Section |
| 308 | Actual Rate Curve |
| 310 | Desired Rate Curve |
| 312 | Second Section |
| 314 | Third Section |
| 316 | Fourth Section |
| 318 | Fifth Section |
| 320 | Sixth Section |
| 322 | Seventh Section |
| 400 | Method of assembling |
| 402 | Coupling at least one blade pitch drive mechanism . . . |
| 404 | Coupling at least one electric power source to the blade . . . |
| 406 | Coupling at least two switch devices to at least one of a first . . . |
| 408 | Coupling the switch devices to the blade pitch drive mechanism, . . . |
| 410 | Coupling a controller to the blade pitch drive mechanism and . . . |
| 412 | Programming the controller to open and close each of the . . . |
| 500 | Method of operating |
| 502 | Coupling one of a plurality of portions of an electric power source . . . |
| 504 | Controlling an angular rate of change of a pitch angle of the . . . |

What is claimed is:

1. A wind turbine blade pitch control system comprising:
at least one blade pitch drive mechanism coupled to a wind turbine blade;
at least one electric power source coupled to said blade pitch drive mechanism, said electric power source comprising a first portion and a second portion;
at least two switch devices coupled to at least one of said first portion and said second portion of said electric power source and to said blade pitch drive mechanism; and,
a controller coupled to said blade pitch drive mechanism and said switch devices, said controller configured to store a plurality of operational measurements of said blade pitch drive mechanism and said switch devices, said controller programmed to change an angular rate of change of a pitch angle of the wind turbine blade by opening and closing said switch devices in a predetermined sequence.

2. A system in accordance with claim 1, wherein said controller is further coupled to at least one of a blade pitch position feedback mechanism and a switch device position feedback mechanism.

3. A system in accordance with claim 1, wherein said first portion and said second portion of said electric power source comprise a plurality of battery units coupled together to define a battery array.

4. A system in accordance with claim 3, wherein each of said switch devices is positioned along said battery array to couple and uncouple a predetermined percentage of said battery array to said blade pitch drive mechanism.

5. A system in accordance with claim 3, wherein each of said switch devices is positioned along said battery array to induce a predetermined voltage on said blade pitch drive mechanism.

6. A system in accordance with claim 3, wherein each of said switch devices is positioned along said battery array to drive said blade pitch drive mechanism at a predetermined angular rate.

7. A system in accordance with claim 1, wherein said controller is further programmed to operate each of said switch devices to induce predetermined voltages on said blade pitch drive mechanism in a predetermined sequence.

8. A method of operating a wind turbine generator including at least one wind turbine blade and at least one blade pitch drive mechanism coupled to the wind turbine blade, said method comprising:
coupling one of a plurality of portions of an electric power source to the blade pitch drive mechanism by closing one of a plurality of switch devices; and,
controlling an angular rate of change of a pitch angle of the wind turbine blade by opening and closing the plurality of switch devices in a predetermined sequence to drive the blade pitch drive mechanism at predetermined angular rates.

9. A method in accordance with claim 8, wherein coupling one of a plurality of portions of an electric power source to the blade pitch drive mechanism comprises:
opening a first switch device and uncoupling a first portion of a battery array from the blade pitch drive mechanism; and,
closing a second switch and coupling a second portion of the battery array to the blade pitch drive mechanism.

10. A method in accordance with claim 8, wherein coupling one of a plurality of portions of an electric power source to the blade pitch drive mechanism comprises opening and closing the switch devices to portions of a battery array to couple and uncouple a predetermined percentage of the battery array to the blade pitch drive mechanism.

11. A method in accordance with claim 8, wherein coupling one of a plurality of portions of an electric power source to the blade pitch drive mechanism comprises opening and closing the switch devices to a battery array to induce a predetermined voltage on the blade pitch drive mechanism.

12. A method in accordance with claim 8, wherein coupling one of a plurality of portions of an electric power source to the blade pitch drive mechanism comprises operating each of the switch devices to couple and uncouple a predetermined percentage of the battery array to and from, respectively, the blade pitch drive mechanism in a predetermined sequence.

13. A method in accordance with claim 8, wherein coupling one of a plurality of portions of an electric power source to the blade pitch drive mechanism comprises operating each of the switch devices to induce predetermined voltages on the blade pitch drive mechanism in a predetermined sequence.

14. A method in accordance with claim 8, wherein coupling one of a plurality of portions of an electric power source to the blade pitch drive mechanism comprises:
increasing the angular rate of change of the pitch angle of the wind turbine blade by coupling a first percentage of a battery array to the blade pitch drive mechanism; and,
decreasing the angular rate of change of the pitch angle of the wind turbine blade by coupling a second percentage of a battery array to the blade pitch drive mechanism, the first percentage is greater than the second percentage.

15. A wind turbine generator comprising:
at least one wind turbine blade; and,
a blade pitch control system comprising:
at least one blade pitch drive mechanism coupled to said wind turbine blade;
at least one electric power source coupled to said blade pitch drive mechanism, said electric power source comprising a first portion and a second portion;
at least two switch devices coupled to at least one of said first portion and said second portion of said electric power source and to said blade pitch drive mechanism; and,
a controller coupled to said blade pitch drive mechanism and said switch devices, said controller configured to store a plurality of operational measurements of said blade pitch drive mechanism and said switch devices, said controller programmed to change an angular rate of change of a pitch angle of said wind turbine blade by opening and closing said switch devices in a predetermined sequence.

16. A wind turbine generator in accordance with claim 15, wherein said controller is further coupled to at least one of a blade pitch position feedback mechanism and a switch device position feedback mechanism.

17. A wind turbine generator in accordance with claim 15, wherein said first portion and said second portion of said electric power source comprise a plurality of battery units coupled together to define a battery array.

18. A wind turbine generator in accordance with claim 17, wherein each of said switch devices is positioned along said battery array to induce a predetermined voltage on said blade pitch drive mechanism.

19. A wind turbine generator in accordance with claim 17, wherein each of said switch devices is positioned along said battery array to induce a predetermined voltage on said blade pitch drive mechanism.

20. A wind turbine generator in accordance with claim 17, wherein each of said switch devices is positioned along said battery array to drive said blade pitch drive mechanism at a predetermined angular rate.
